(19) United States
(12) Patent Application Publication
(10) Pub. No.: US 2024/0382907 A1
(43) Pub. Date: Nov. 21, 2024

(54) COMPOSITE SEMIPERMEABLE MEMBRANE

(71) Applicant: TORAY INDUSTRIES, INC., Tokyo (JP)

(72) Inventors: Kumiko OGAWA, Shiga (JP); Harutoki SHIMURA, Shiga (JP); Takafumi OGAWA, Shiga (JP)

(73) Assignee: TORAY INDUSTRIES, INC., Tokyo (JP)

(21) Appl. No.: 18/693,578

(22) PCT Filed: Sep. 26, 2022
(86) PCT No.: PCT/JP2022/035764

§ 371 Date: Mar. 20, 2024

(30) Foreign Application Priority Data
Sep. 27, 2021 (JP) 2021-156465

(51) Int. Cl. B01D 69/12; B01D 69/02; B01D 71/56

(52) U.S. Cl. CPC B01D 69/1251; B01D 69/02; B01D 71/56; B01D 2325/04; B01D 2325/06; B01D 2325/24

(57) ABSTRACT

The present invention relates to a composite semipermeable membrane including: a microporous support layer; and a separation functional layer provided on the microporous support layer, in which the separation functional layer includes a plurality of protrusions formed of a thin membrane including a cross-linked aromatic polyamide, in arbitrary ten cross sections perpendicular to a membrane surface direction and having a length of 2.0 μm in the membrane surface direction, an average number density of the protrusions whose height with respect to a surface of the support layer as reference is one-fifth or more of a ten-point average surface roughness of the separation functional layer is 13.0 protrusions/μm or more, and an average value of a deformation amount when the protrusions are pressed with a force of 5 nN is 2.2 nm or less, and a standard deviation of the deformation amount is 1.2 nm or less.

### TECHNICAL FIELD

The present invention relates to a composite semipermeable membrane useful for selective separation of a liquid mixture.

### BACKGROUND ART

There are various techniques for removing substances (for example, salts) dissolved in a solvent (for example, water) in relation to separation of a liquid mixture, and in recent years, membrane separation methods have been widely used as processes for energy saving and resource saving. Membranes used in the membrane separation method include a microfiltration membrane, an ultrafiltration membrane, a nanofiltration membrane, a reverse osmosis membrane, and the like, and these membranes are used, for example, to obtain drinking water from water containing salt and a harmful substance, and the like, to produce ultrapure water for industrial use, to treat wastewater, or to recover a valuable material.

Most of reverse osmosis membranes and nanofiltration membranes that are currently commercially available are composite semipermeable membranes in which a separation functional layer having separation performance such as salts is coated on a support membrane, and there are two types of composite semipermeable membranes, one having an active layer in which a gel layer and a polymer are cross-linked on the support membrane, and the other having an active layer in which a monomer is polymerized on the support membrane. Among the latter composite semipermeable membranes, a composite semipermeable membrane (see Patent Literature 1) including a separation functional layer containing a crosslinked polyamide obtained by a polycondensation reaction of a polyfunctional amine and a polyfunctional acid halide is widely used as a separation membrane having high permeability and high selective separability.

In a water desalination plant using a reverse osmosis membrane, higher water permeability is required to further reduce running costs. In addition, in a case where the composite semipermeable membrane is used as a reverse osmosis membrane, it is required that the membrane performance can be maintained even under operation conditions that an operation is performed for a long time at high pressure or the operation and stop are frequently repeated and pressure fluctuates. In order to prevent a change in performance when the composite semipermeable membrane is operated, a method for preventing the compaction of the porous support membrane has been proposed (see Patent Literatures 2 and 3).

### CITATION LIST

### Patent Literature

Patent Literature 1: WO2010/096563

Patent Literature 2: JP2001-179061A

Patent Literature 3: JP3385824B

### SUMMARY OF INVENTION

### Technical Problem

However, in the composite semipermeable membrane in the related art, in a situation where the pressure applied to the membrane fluctuates, such as when the operation and stop are repeated frequently, the water permeability or the salt removability may decrease.

An object of the present invention is to provide a composite semipermeable membrane capable of achieving both high salt removability and water permeability even under a condition that pressure fluctuates.

### Solution to Problem

In order to achieve the above object, the composite semipermeable membrane of the present invention includes any of the following configurations.
[1] A composite semipermeable membrane including:
a microporous support layer; and
a separation functional layer provided on the microporous support layer, in which
the separation functional layer includes a plurality of protrusions formed of a thin membrane including a cross-linked aromatic polyamide,
in arbitrary ten cross sections perpendicular to a membrane surface direction and having a length of 2.0 μm in the membrane surface direction, an average number density of the protrusions whose height with respect to a surface of the support layer as reference is one-fifth or more of a ten-point average surface roughness of the separation functional layer is 13.0 protrusions/μm or more, and
an average value of a deformation amount when the protrusions are pressed with a force of 5 nN is 2.2 nm or less, and a standard deviation of the deformation amount is 1.2 nm or less.
[2] The composite semipermeable membrane according to [1], in which the average value of the deformation amount when the protrusions are pressed with the force of 5 nN is 1.7 nm or less.
[3] The composite semipermeable membrane according to [1] or [2], in which the average number density of the protrusions is 15.0 protrusions/μm or more.
[4] The composite semipermeable membrane according to any one of [1] to [3], in which the standard deviation of the deformation amount is 0.98 nm or less.
[5] The composite semipermeable membrane according to any one of [1] to [4], in which a value of x+y calculated from amounts of amino groups, carboxyl groups, and amide groups of the separation functional layer is 0.70 or less,
provided that the x is defined as a molar ratio of the carboxyl groups to the amide groups measured by ¹³C solid NMR, and the y is defined as a molar ratio of the amino groups to the amide groups measured by the ¹³C solid NMR.
[6] The composite semipermeable membrane according to any one of [1] to [5], in which a thickness of the thin membrane in the protrusion is 10 nm or more and 20 nm or less.
[7] The composite semipermeable membrane according to any one of [1] to [6], in which a weight of the separation functional layer is 0.10 g/m² or more.
[8] The composite semipermeable membrane according to any one of [1] to [7], in which the separation functional layer includes a cross-linked fully aromatic polyamide.

A method for producing a composite semipermeable membrane of the present invention includes any of the following configurations.
[9] A method for producing the composite semipermeable membrane according to any one of [1] to [8], the method including:
a step of performing an interfacial polycondensation on a surface of a support membrane including a microporous support layer by using a polyfunctional aromatic amine solution in which a sum a+b of a dissolved amount a of oxygen and a dissolved amount b of carbon dioxide in the solution in a case of a solution temperature of 25° C. is 9 mg/L or more and a solution obtained by dissolving a polyfunctional aromatic acid halide in an organic solvent, and then heating to form a cross-linked polyamide functional layer.
[10] The method for producing the composite semipermeable membrane according to [9], in which a ratio b/a of the dissolved amount b to the dissolved amount a is 0.90 or more.

A water treatment system of the present invention includes the following configuration.
[11] A water treatment system for separating a supply water into a concentrate and a fresh water by using the composite semipermeable membrane according to any one of [1] to [8].

### Advantageous Effects of Invention

According to the present invention, a composite semipermeable membrane having both high salt removability and water permeability is realized under a condition that an operation and stop are repeated frequently and pressure fluctuates.

### BRIEF DESCRIPTION OF DRAWINGS

FIG. 1 is a cross-sectional view schematically showing a structure of a composite semipermeable membrane, (a) of FIG. 1 is a schematic cross-sectional view of the composite semipermeable membrane, (b) of FIG. 1 is an enlarged schematic view of a separation functional layer, and (c) of FIG. 1 is an enlarged cross-sectional view schematically showing a fold structure of the separation functional layer.

FIG. 2 is a schematic view showing a fold structure of a thin membrane in the separation functional layer.

FIG. 3 is a diagram schematically showing a method for measuring a deformation amount of a convex portion of the separation functional layer.

### DESCRIPTION OF EMBODIMENTS

Hereinafter, embodiments of the present invention will be described in detail, but the present invention is not limited in any way by these embodiments.

In the present description, “mass” is synonymous with “weight”.

### 1. Composite Semipermeable Membrane

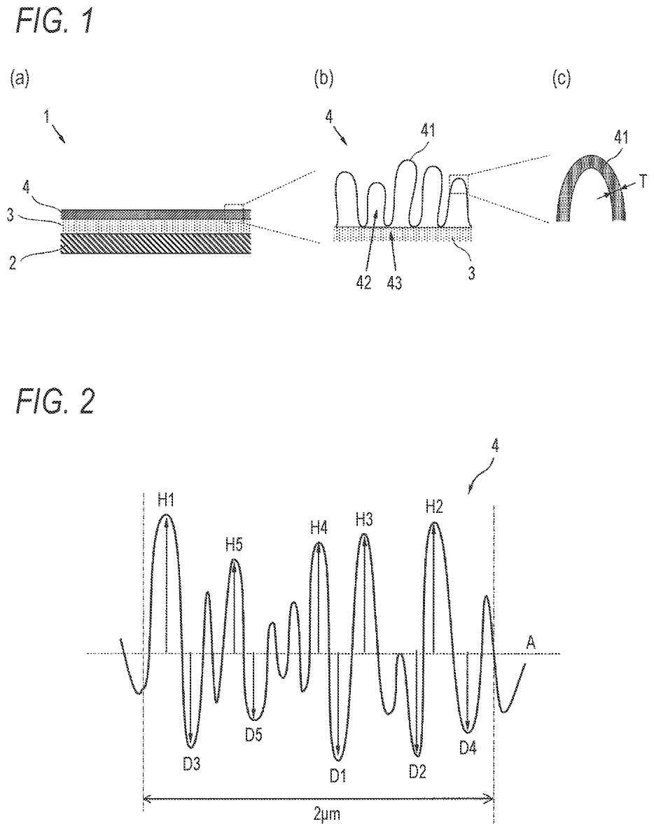

FIG. 1 shows a structure of a composite semipermeable membrane 1 according to the present embodiment. As shown in FIG. 1, the composite semipermeable membrane 1 according to the present invention includes a microporous support layer 3 and a separation functional layer 4 provided on the microporous support layer 3.

The microporous support layer 3 may be formed on a substrate 2, and the composite semipermeable membrane 1 according to the embodiment of the present invention may include a support membrane including the substrate 2 and the microporous support layer 3 formed on the substrate 2.

The separation functional layer 4 substantially has a separation performance, and the microporous support layer 3 substantially does not have a separation performance for ions or the like, and can impart strength to the separation functional layer 4.

### (1-1) Support Membrane

The support membrane may include the substrate 2 and the microporous support layer 3, or the support membrane may include only the microporous support layer 3 without including the substrate 2. That is, the microporous support layer 3 may be a support membrane.

Examples of the substrate 2 include fabrics made of polyester-based polymers, polyamide-based polymers, polyolefin-based polymers and mixtures thereof, or copolymers thereof. Among them, a fabric made of polyester-based polymers having high mechanical and thermal stability is preferable. In the form of fabric, a long-fiber nonwoven fabric or a short-fiber nonwoven fabric, or a woven or knitted fabric can be preferably used.

The microporous support layer 3 has a large number of fine pores communicating with each other. A pore diameter and a pore diameter distribution of the fine pores are not particularly limited, and for example, it is preferable that the microporous support layer has a symmetric structure having a uniform pore diameter, or an asymmetric structure in which the pore diameter gradually increases from one surface to the other surface, and the pore diameter on the surface having a smaller pore diameter is 0.1 nm to 100 nm.

As the material of the microporous support layer 3, homopolymers or copolymers such as polysulfones (hereinafter also referred to as “PSf”), polyethersulfones, polyamides, polyesters, cellulose-based polymers, vinyl polymers, polyphenylene sulfides, polyphenylene sulfide sulfones, polyphenylene sulfones, and polyphenylene oxides can be used alone or blended for use. Examples of the cellulose-based polymer include cellulose acetate and cellulose nitrate, and examples of the vinyl polymer include polyethylene, polypropylene, polyvinyl chloride, and polyacrylonitrile. Among these, homopolymers or copolymers such as PSf, polyamides, polyesters, cellulose acetate, cellulose nitrate, polyvinyl chloride, polyacrylonitrile, polyphenylene sulfides, polyphenylene sulfide sulfones are preferable, cellulose acetate, PSf, polyphenylene sulfide sulfones, or polyphenylene sulfones are more preferable, and PSf is particularly preferable because PSf has high chemical, mechanical, and thermal stability and is easily molded.

A weight average molecular weight (hereinafter also referred to as “M_{w}”) of PSf is preferably 10,000 to 200,000, and more preferably 15,000 to 100,000. When M_{w} of PSf is 10,000 or more, preferable mechanical strength and heat resistance can be obtained as a microporous support layer. On the other hand, when M_{w} of PSf is 200,000 or less, the viscosity of a microporous support layer raw solution is in an appropriate range, and good moldability can be realized.

A thickness of the substrate and the microporous support layer affect the strength of the composite semipermeable membrane and the packing density when the composite semipermeable membrane is used as an element. In order to obtain good mechanical strength and packing density, a total thickness of the substrate and the microporous support layer is preferably 30 μm to 300 μm, and more preferably 100 μm to 220 μm. The thickness of the microporous support layer is preferably 20 μm to 100 μm. The thickness of the substrate and the microporous support layer can be obtained by calculating an average value of thicknesses at 20 points measured at an interval of 20 μm in a direction (surface direction of the membrane) orthogonal to a thickness direction in cross-sectional observation.

### (1-2) Separation Functional Layer

The separation functional layer 4 is a layer that functions as a solute separation function, and contains a cross-linked aromatic polyamide. The separation functional layer 4 preferably contains a cross-linked aromatic polyamide as a main component.

The expression “contains a cross-linked aromatic polyamide as a main component” means that a ratio occupied by the cross-linked aromatic polyamide in the separation functional layer is 50 mass % or more. The ratio occupied by the cross-linked aromatic polyamide in the separation functional layer is preferably 80 mass % or more, more preferably 90 mass % or more, and the separation functional layer is more preferably substantially formed of only the cross-linked aromatic polyamide. The expression “the separation functional layer is substantially formed of only the cross-linked aromatic polyamide” means that 99 mass % or more of the separation functional layer is occupied by the cross-linked aromatic polyamide.

Examples of the cross-linked aromatic polyamide include aramid compounds, but the molecular structure may contain a site other than an aromatic site. However, the cross-linked fully aromatic polyamide is more preferable from the viewpoint of the rigidity, chemical stability, and durability against an operation pressure. The cross-linked aromatic polyamide can be formed by interfacial polycondensation between a polyfunctional aromatic amine and a polyfunctional aromatic acid halide. Here, at least one of the polyfunctional aromatic amine and the polyfunctional aromatic acid halide preferably contains a trifunctional or higher functional compound. Hereinafter, the separation functional layer in the present invention may be referred to as a polyamide separation functional layer.

The polyfunctional aromatic amine means an aromatic amine having two or more amino groups of at least one of a primary amino group and a secondary amino group in one molecule, and at least one of the amino groups is a primary amino group.

Examples of the polyfunctional aromatic amine include polyfunctional aromatic amines in which two amino groups are bonded to an aromatic ring in any positional relationship of an ortho position, a meta position, and a para position, such as o-phenylenediamine, m-phenylenediamine, p-phenylenediamine, o-xylylenediamine, m-xylylenediamine, p-xylylenediamine, o-diaminopyridine, m-diaminopyridine, and p-diaminopyridine; and polyfunctional aromatic amines such as 1,3,5-triaminobenzene, 1,2,4-triaminobenzene, 3,5-diaminobenzoic acid, 3-aminobenzylamine, and 4-aminobenzylamine.

In particular, in consideration of selective separability, permeability, and heat resistance of the membrane, m-phenylenediamine, p-phenylenediamine, and 1,3,5-triaminobenzene are preferably used. Among them, m-phenylenediamine (hereinafter also referred to as m-PDA) is more preferably used in view of availability and ease of handling. These polyfunctional aromatic amines may be used alone or in combination of two or more thereof.

The polyfunctional aromatic acid halide refers to an aromatic acid halide having at least two halogenated carbonyl groups in one molecule. Examples of a trifunctional acid halide include trimesic acid chloride, and examples of a bifunctional acid halide include biphenyl dicarboxylic acid dichloride, azo benzene dicarboxylic acid dichloride, terephthalic acid chloride, isophthalic acid chloride, and naphthalene dicarboxylic acid chloride.

In consideration of reactivity with the polyfunctional aromatic amine, the polyfunctional aromatic acid halide is preferably a polyfunctional aromatic acid chloride. In addition, in consideration of selective separability and heat resistance of the membrane, it is more preferable to use a polyfunctional aromatic acid chloride having 2 to 4 carbonyl chloride groups in one molecule.

The shape and thickness of the separation functional layer influence the separation performance and permeability. As shown in (b) of FIG. 1, the separation functional layer 4 includes a thin membrane 41 having a pleated shape with a plurality of convex portions 42 and concave portions 43, and in the layer made of the thin membrane 41, protrusions are formed by adjacent convex portions 42 and concave portions 43. When the separation functional layer includes a pleated thin membrane, a specific surface area of the separation functional layer can be significantly increased as compared with a planar structure. As a result, it is possible to improve the permeability in proportion to a surface area of the separation functional layer while maintaining the separation performance. As shown in (c) of FIG. 1, the inside of the convex portion 42 (between the thin membrane 41 and the microporous support layer 3) is a void. The convex portion and the concave portion will be described with reference to FIG. 2. The term “convex portion” and the term “concave portion” refer to a relatively protruding portion and a relatively recessed portion of the thin membrane, and in particular, a portion above a reference line A to be described later is referred to as a convex portion, and a portion below is referred to as a concave portion. The term “protrusion” refers to a portion from a bottom of a concave portion to a bottom of an adjacent concave portion, that is, a portion from one convex portion to bottoms of two concave portions adjacent thereto. In the following description, the term “protrusion” refers to a portion whose height with respect to a surface of the support layer as a reference is one-fifth or more of a ten-point average surface roughness of the thin membrane.

The present inventors have found that, when an average value of a deformation amount in a case where the protrusion, specifically, the convex portion forming the protrusion is pushed in pure water at 25° C. with a force of 5 nN is 2.2 nm or less and a standard deviation of the deformation amount is 1.2 nm or less, a stable membrane performance can be obtained even under a condition that pressure fluctuates due to frequent repetition of operation and stop.

A deformation amount of the protrusion can be calculated as follows. A surface of the separation functional layer is observed with an atomic force microscope (AFM) in pure water at 25° C., and arbitrary two regions with a 2 μm square area are selected. The protrusions included in the two regions, specifically, the convex portions, are selected at 10 points in each region, that is, 20 points in total. Further, one point in a circular region having a diameter of 100 nm with a vertex of the selected protrusion (convex portion) as a center is pushed with a force of 5 nN to obtain a deformation amount. An arithmetic average value of the obtained 20-point deformation amounts is taken as an average value of the deformation amount.

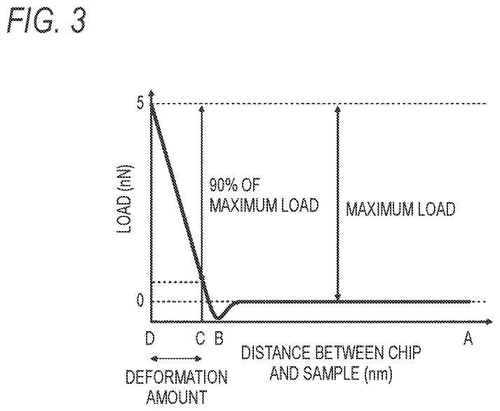

The deformation amount of the protrusion (convex portion) can be measured using an atomic force microscope (AFM) in a tapping mode. Specifically, as shown in FIG. 3, on a force curve in which a horizontal axis represents a chip-sample distance (separation) and a vertical axis represents a load, when a point before a cantilever is brought close to the sample is defined as a point A, a moment at which the load rises is defined as a point B, a point at which the load is 90% of a maximum load is defined as a point C, and a maximum load point is defined as a point D, a distance between the points C and D is defined as a deformation amount. A force curve when the cantilever is brought close to the sample is used.

As the atomic force microscope, for example, Dimension FastScan manufactured by Bruker AXS can be used. By using an accessory attachment, observation in water is possible. At this time, a shape of a probe for the cantilever used is a conical shape (pyramidal shape). Before using the cantilever, calibration is performed. First, a deflection sensitivity of the cantilever is measured with a substance having sufficient hardness. A silicon wafer or sapphire can be used as the substance having sufficient hardness. Next, a spring constant of the cantilever is measured by thermal tune. By performing the calibration, measurement accuracy is improved.

The deformation amount of the protrusion (convex portion) in the separation functional layer reflects the density of the pore structure of the separation functional layer. Specifically, the rougher the pore structure of the separation functional layer, the larger the deformation amount, and the denser the pore structure, the smaller the deformation amount. When the average value of the deformation amounts is 2.2 nm or less, the separation functional layer has a sufficiently dense structure, and thus compaction is estimated to be less likely to occur even if high pressure is applied locally at the time of a change in the operation pressure. The average value of the deformation amount is more preferably 1.7 nm or less. On the other hand, when the deformation amount is too small, the functional layer is too dense, and sufficient water permeability cannot be obtained. In addition, since the flexibility is low, the physical structural stability is reduced when the membrane is subjected to impact such as bending, folding, or shaking, and a pinhole defect is more likely to occur. Therefore, the average value of the deformation amount is preferably 0.5 nm or more.

Even when the average value of the deformation amount is 2.2 nm or less, if a portion of the functional layer is coarse and a portion of the functional layer is dense, a defect occurs in the coarse portion when high pressure is locally applied, and the salt removal rate is likely to decrease. When the standard deviation of the deformation amount is 1.2 nm or less, excessive coarse portions and excessive dense portions are preferably reduced. The standard deviation of the deformation amount is more preferably 0.98 nm or less. On the other hand, in order to achieve both mechanical strength and elasticity of the separation functional layer, the standard deviation of the deformation amount is preferably 0.1 nm or more.

The protrusion of the thin membrane can be observed by an electron microscope such as a scanning electron microscope (SEM, FE-SEM) or a transmission electron microscope (TEM). First, in order to prepare an ultrathin section for the TEM, a sample is embedded in a water-soluble polymer. Any water-soluble polymer may be used as long as the polymer can maintain a shape of the sample, and an example thereof is polyvinyl alcohol (PVA). Next, in order to facilitate cross-section observation, the sample is stained with osmium tetroxide OsO₄, and the stained sample is cut with an ultramicrotome to prepare an ultrathin section. A cross-sectional image of the obtained ultrathin section is captured using an electron microscope. An observation magnification may be appropriately determined based on the membrane thickness of the separation functional layer, and, in order to observe a cross-sectional shape of the separation functional layer and prevent the measurement from being localized, the observation magnification may be set to 50,000 to 100,000 times if the thickness of the separation functional layer is 10 nm to 100 nm.

The ten-point average surface roughness of the thin membrane is obtained by the following method.

A cross section in a direction perpendicular to the membrane surface is observed using an electron microscope. An observation magnification is preferably 10,000 to 100,000 times. In an obtained cross-sectional image, as shown in (a) and (b) of FIG. 1, a surface of the composite semipermeable membrane (denoted by reference numeral “1” in FIG. 1) appears as a curve. For this curve, a roughness curve defined based on ISO 4287:1997 is obtained. Similarly, an average line of the roughness curve is obtained based on ISO 4287:1997. The average line is a straight line drawn such that total areas of regions surrounded by the average line and the roughness curve above and below the average line are equal.

As shown in FIG. 2, in an image having a width of 2.0 μm parallel to the average line obtained above, the average line is set as the reference line A, and heights (distances from the reference line A to vertices of convex portions) H1 to H5 from the reference line A are measured for five convex portions from the highest convex portion to a fifth highest convex portion, and an average value thereof is calculated. In addition, depths (distances from the reference line A to vertices of concave portions) D1 to D5 are measured for five concave portions from the deepest concave portion to the fifth deepest concave portion, and an average value thereof is calculated. A sum of the obtained two average values is the ten-point average surface roughness. A vertex refers to a point at which a distance from the reference line is maximum on the convex portion or the concave portion.

A height of the protrusion is calculated as follows. In ten point cross sections having a width of 2.0 μm parallel to the average line, for a protrusion that is one-fifth or more of the ten-point average surface roughness, a sum of an average d of depths (distances from the reference line to vertices of concave portions) d1 and d2 at both ends of the protrusion and a convex portion height h (a distance from the reference line to a vertex of a convex portion) is calculated as a protrusion height Ph.

A height of the protrusion is preferably 70 nm or more. The height of the protrusion is preferably 1000 nm or less, more preferably 800 nm or less. When the height of the protrusion is 70 nm or more, a composite semipermeable membrane having sufficient water permeability can be easily obtained. In addition, when the height of the protrusion is 1000 nm or less, the protrusion is not crushed even when the composite semipermeable membrane is used under high-pressure operation, and thus stable membrane performance can be obtained.

An average thickness of the thin membrane on the protrusion can be measured by a TEM. The preparation of the ultrathin section for the TEM is as described above. A cross section of the obtained ultrathin section is imaged by the TEM. An observation magnification may be appropriately determined depending on the thickness of the separation functional layer. The obtained cross-sectional image can be analyzed with image analysis software.

An average value of a thickness T of the thin membrane is preferably 10 nm or more and 20 nm or less. When the average value of T is 10 nm or more, good separation performance is obtained, and durability against external physical forces is improved. When the average value of T is 20 nm or less, a composite semipermeable membrane having good permeability can be obtained. The average value of the thickness T is more preferably 15 nm or less.

The average number density of the protrusions in the separation functional layer is 13.0 protrusions/μm or more, and more preferably 15.0 protrusions/μm or more. The average number density of the protrusions in the separation functional layer is preferably 50 protrusions/μm or less, more preferably 40 protrusions/μm or less. When the average number density of the protrusions is 13.0 protrusions/μm or more, the composite semipermeable membrane can obtain sufficient water permeability, further, deformation of the protrusions during pressurization can be inhibited, and stable membrane performance can be obtained. In addition, when the number density of the protrusions is 50 protrusions/μm or less, growth of a fold structure is sufficient, and a composite semipermeable membrane having desired water permeability can be easily obtained. The average number density of the protrusion can be measured from the number of protrusions that is one-fifth or more of the ten-point average surface roughness described above in each cross section when the ten cross sections each having a width of 2.0 μm are observed.

The polyamide separation functional layer contains amide groups derived from polymerization of a polyfunctional aromatic amine and a polyfunctional aromatic acid halide, and amino groups and a carboxyl groups derived from unreacted functional groups.

When a molar ratio of the carboxyl groups to the amide groups (carboxyl groups/amide groups) in the separation functional layer is x and a molar ratio of the amino groups to the amide groups (amino groups/amide groups) is y, x+y is preferably 0.70 or less. More preferably, x+y is 0.60 or less. When x+y is small, a molar ratio of the amide groups to a total amount of the amino groups and the carboxyl groups is large, and the polymer has a dense structure, and thus compaction is estimated to be less likely to occur even if high pressure is applied locally at the time of a change in the operation pressure.

Molar ratios of the carboxyl groups, the amino groups, and the amide groups of the separation functional layer can be determined by ¹³C solid NMR measurement of the separation functional layer. Specifically, the substrate is peeled from the composite semipermeable membrane 5 m² to obtain a polyamide separation functional layer and a microporous support layer, and then the microporous support layer is dissolved and removed to obtain a polyamide separation functional layer. The obtained polyamide separation functional layer is measured by DD/MAS-¹³C solid NMR, and each ratio can be calculated from the comparison of a carbon peak of each functional group or an integrated value of the carbon peak to which each functional group is bonded.

A weight of the separation functional layer of the present invention is preferably 0.10 g/m² or more, more preferably 0.11 g/m² or more, further preferably 0.12 g/m² or more. If the weight of the separation functional layer is 0.10 g/m² or more, there is a sufficient amount of polyamide constituting the separation functional layer, so durability against external physical forces is improved, and stable membrane performance can be obtained even under a condition that pressure fluctuates.

In order to prevent a substance to be separated from penetrating into the composite semipermeable membrane, the separation functional layer is preferably disposed on a surface side of the composite semipermeable membrane, and more preferably disposed on a primary filtration side.

### 2. Method for Producing Composite Semipermeable Membrane

A method for producing a composite semipermeable membrane of the present invention is not particularly limited as long as a composite semipermeable membrane that satisfies the above-described desired characteristics can be obtained, and the composite semipermeable membrane can be produced, for example, by the following method.

### (2-1) Formation of Support Membrane

As a method for forming a support membrane, a known method can be suitably used. Hereinafter, a case where PSf is used as a material of the microporous support layer will be described as an example.

First, PSf is dissolved in a good solvent of PSf to prepare a microporous support layer raw solution. As the good solvent of PSf, for example, N,N-dimethylformamide (hereinafter, referred to as “DMF”) is preferable.

A concentration of PSf in the microporous support layer raw solution is preferably 10 to 25 mass %, and more preferably 14 to 23 mass %. As the polymer concentration (that is, solid content) of a polymer solution is higher, a microporous support layer having higher number density of particles on a surface of the microporous support layer is obtained, and as a result, the number density of the protrusions in the separation functional layer also increases, and a protrusion structure that can withstand pressure fluctuations can be realized. In addition, since the polymer concentration is low to such an extent that a monomer supply rate at the time of forming the separation functional layer is not too low, a surface fine pore diameter of the microporous support layer is adjusted, and a protrusion having an appropriate height is formed at the time of forming the separation functional layer. When the concentration of PSf in the microporous support layer raw solution is within this range, it is possible to achieve both the strength and the permeability of the obtained microporous support layer. A preferable range of the concentration of the material in the microporous support layer raw solution can be appropriately adjusted according to the material to be used, the good solvent, and the like.

Next, the obtained microporous support layer raw solution is applied to a surface of the substrate, and is immersed in a coagulation bath containing a non-solvent of PSf.

The non-solvent of PSf contained in the coagulation bath is preferably water, for example. By bringing the microporous support layer raw solution applied on the surface of the substrate into contact with the coagulation bath containing the non-solvent of PSf, the microporous support layer raw solution is solidified by the non-solvent induced phase separation, and a support membrane in which a microporous support layer is formed on the surface of the substrate can be obtained.

The coagulation bath may be composed of only the non-solvent of PSf, or may contain the good solvent of PSf in a range in which the microporous support layer raw solution can be coagulated.

The solvent remaining in the membrane may be removed by washing the obtained support membrane before the formation of the separation functional layer.

### (2-2) Polymerization Step of Separation Functional Layer

As a method for forming a separation functional layer containing a cross-linked aromatic polyamide, a method for polymerizing and solidifying a polyfunctional aromatic amine and a polyfunctional aromatic acid halide on a support membrane obtained by “(2-1) formation of support membrane” will be described as an example. A polymerization method is performed by interfacial polymerization from the viewpoint of productivity and performance. An interfacial polymerization step is described below.

The method for producing a composite semipermeable membrane of the present invention includes a step of performing interfacial polycondensation on a surface of a support membrane including a microporous support layer by using a polyfunctional aromatic amine solution in which a sum a+b of a dissolved amount a of oxygen and a dissolved amount b of carbon dioxide in the solution at a solution temperature of 25° C. is 9 mg/L or more and a solution obtained by dissolving a polyfunctional aromatic acid halide in an organic solvent, and then heating to form a cross-linked polyamide functional layer.

More specifically, the interfacial polymerization step includes (a) a step of bringing, into contact with a support membrane, an amine solution that contains a polyfunctional aromatic amine and in which a sum a+b of a dissolved amount a of oxygen and a dissolved amount b of carbon dioxide in the solution at a solution temperature of 25° C. is 9 mg/L or more; (b) a step of bringing an organic solvent solution containing a polyfunctional aromatic acid halide into contact with a support membrane which has been brought into contact with the amine solution containing the polyfunctional aromatic amine; (c) a step of heating the membrane after being brought into contact with the amine and the acid halide; and (d) a step of washing, with hot water, a composite semipermeable membrane including the cross-linked polyamide functional layer on the support membrane formed in step (c).

Examples of the microporous support layer, the polyfunctional aromatic amine, and the polyfunctional aromatic acid halide include those described above, and preferred examples thereof are also the same.

In step (a), a concentration of the polyfunctional aromatic amine in a polyfunctional aromatic amine solution is preferably in the range of 0.1 wt % or more and 20 wt % or less, and more preferably in the range of 0.5 wt % or more and 15 wt % or less. When the concentration of the polyfunctional aromatic amine falls within this range, sufficient solute removability and water permeability can be obtained. Two or more kinds of polyfunctional aromatic amines may be used.

The polyfunctional aromatic amine solution may contain a surfactant, an organic solvent, an alkaline compound, an antioxidant, or the like, as long as the reaction between the polyfunctional aromatic amine and the polyfunctional aromatic acid halide is not hindered. The surfactant has an effect of improving wettability of a support membrane surface and reducing an interfacial tension between the polyfunctional aromatic amine solution and a non-polar solvent. The organic solvent may act as a catalyst for the interfacial polycondensation reaction, and the interfacial polycondensation reaction may efficiently be performed owing to addition of the organic solvent.

In the polyfunctional aromatic amine solution, when a dissolved amount of oxygen in the solution at a solution temperature of 25° C. is a (mg/L) and a dissolved amount of carbon dioxide is b (mg/L), a dissolved gas amount a+b is set to 9 mg/L or more. Here, a+b is preferably 15 mg/L or more, more preferably a+b is 32 mg/L or more, further preferably a+b is 100 mg/L or more. As a method for adjusting a dissolved amount of a gas, there is a method for bringing a gas with a predetermined mixing ratio into contact with a solution, a method for press-fitting and dissolving a gas, and a method for using a commercially available solution (for example, carbonated water) in which a gas is dissolved in advance. If the reaction between the polyfunctional aromatic amine and the polyfunctional aromatic acid halide is not hindered, a gas may be generated using a chemical reaction. When a commercially available liquid in which a gas is dissolved in advance is used, a dissolved amount may be reduced to a predetermined amount by degasification performed by an ultrasonic wave or a vacuum pump. These methods can be freely selected.

In general, by a heating step in step (c) to be described below, the functional layer becomes denser, the average value of the deformation amount of the protrusions (convex portions) becomes smaller, and the average value of the deformation amount is 2.2 nm or less. However, at the same time, the coalescence of the protrusions progresses, so the number density of protrusions decreases, and the average number density of protrusions becomes not 13.0 protrusions/μm or more. On the other hand, when the dissolved gas amount a+b is increased, a starting point for forming the protrusions is increased by the generation of microbubbles to be described later, and the average number density of the protrusions is 13.0 protrusions/μm or more even after the heating step. By increasing the dissolved gas amount a+b, it is possible to prevent the locally progress of the reaction due to the inhibition of the agglomeration in a portion where the molecules become dense at the time of interfacial polymerization, and thus it is possible to prevent the formation of the coarse portion and the dense portion. Therefore. variation in the deformation amount decreases, and the standard deviation is 1.2 nm or less. On the other hand, when a gas is pressurized, the dissolved gas amount can be excessively increased, but when the dissolved gas amount is too large, a defect is likely to occur in the protrusion, and a removal rate decreases, so the dissolved gas amount a+b is preferably 10,000 or less.

In step (a), the polyfunctional aromatic amine solution is preferably uniformly and continuously brought into contact with the support membrane. Specific examples thereof include a method for coating a support membrane with a polyfunctional aromatic amine solution, and a method for immersing a support membrane in a polyfunctional aromatic amine solution. A contact time between the support membrane and the polyfunctional aromatic amine solution is preferably 1 second to 10 minutes, and more preferably 3 seconds to 3 minutes.

After the polyfunctional aromatic amine solution is brought into contact with the support membrane, it is preferable to sufficiently remove liquid such that no droplet remains on the support membrane. By sufficiently removing liquid, it is possible to prevent droplet residue from becoming a membrane defect after composite semipermeable membrane formation and deteriorating separation performance. Examples of a liquid removal method include, as disclosed in JPH2-78428A, a method for holding the support membrane in a vertical direction after the contact with the aqueous solution and allowing the excessive aqueous solution to naturally flow down, or a method for forcibly removing liquid by blowing an air flow such as nitrogen from an air nozzle. In addition, after the liquid removal, the membrane surface can be dried to partially remove water of the aqueous solution.

Examples of the polyfunctional aromatic acid halide in step (b) include polyfunctional aromatic acid chloride such as trimesic acid chloride (hereinafter referred to as “TMC”), biphenyl dicarboxylic acid dichloride, azo benzene dicarboxylic acid dichloride, terephthalic acid chloride, isophthalic acid chloride, naphthalene dicarboxylic acid chloride, and 2,5-furan dicarboxylic acid chloride. The polyfunctional aromatic acid halide may be used alone or in combination of two or more thereof.

The organic solvent is preferably immiscible with water, dissolves the polyfunctional aromatic acid halide, does not erode the support membrane, and is inactive to the polyfunctional aromatic amine and the polyfunctional aromatic acid halide. Examples of the organic solvent include hydrocarbon compounds such as n-nonane, n-decane, n-undecane, n-dodecane, isooctane, isodecane, and isododecane, and mixed solvents thereof.

A concentration of the polyfunctional aromatic acid halide in the organic solvent solution is preferably 0.01 mass % to 10 mass %, more preferably 0.02 mass % to 4 mass %, and still more preferably 0.03 mass % to 2 mass %. When the concentration of the polyfunctional aromatic acid halide is 0.01 mass % or more, the polymerization can proceed at a sufficient reaction rate. On the other hand, when the concentration of the polyfunctional aromatic acid halide is 10 mass % or less, a side reaction during polymerization can be prevented. The organic solvent solution may contain a compound such as a surfactant as necessary as long as the polymerization is not inhibited.

A method for bringing the organic solvent solution of the polyfunctional aromatic acid halide into contact with the support membrane which has been brought into contact with the polyfunctional aromatic amine solution may be performed in the same manner as a method for coating the support membrane with the polyfunctional aromatic amine solution.

A temperature at which the microporous support layer which has been brought into contact with the aqueous solution containing the polyfunctional aromatic amine is brought into contact with a solution in which the polyfunctional aromatic acid halide is dissolved is preferably 25° C. to 60° C., and more preferably 30° C. to 55° C. When the temperature is less than 25° C., the protrusion height may not be sufficiently obtained. As the temperature increases, a solubility of gas decreases, and the undissolved gas generates microbubbles, increasing the number of starting points for forming protrusions, but when the temperature exceeds 60° C., a reaction speed is too fast, the thin membrane thickness of the protrusions increases, the coalescence of the protrusions proceeds, and sufficient water permeability cannot be obtained. When the contact temperature is 25° C. to 60° C., the number of protrusions increases and a surface area of a reaction interface substantially increases, so that an amount of polyamide increases and an increase in film thickness T can be prevented. As a method for imparting the temperature, the support membrane may be heated, or a heated organic solvent solution of the polyfunctional acid halide may be brought into contact. The temperature of the membrane surface immediately after the polyfunctional aromatic amine solution is brought into contact with the polyfunctional acid halide solution can be measured with a non-contact thermometer such as a radiation thermometer.

In step (c), after an organic solvent solution of polyfunctional aromatic acid chloride is brought into contact, the support membrane is heat-treated. In the case of heat treatment, a heating temperature is preferably 50° C. to 180° C., more preferably 60° C. to 160° C., further preferably 80° C. to 150° C. Since it is possible to obtain a synergistic effect of heating, accelerating an interfacial polymerization reaction due to an increase in surface area by microbubbles generated by heating, accelerating interfacial polymerization due to concentration of a polyfunctional aromatic acid halide during interfacial polymerization, and improving reaction efficiency due to improvement in mobility of a monomer or an oligomer, an amount of polyamide in the separation functional layer is 0.10 g/m² or more, an amount of the amide groups increases, and x+y is 0.70 or less. The densification of the functional layer proceeds, and the average value of the deformation amount is 2.2 nm or less. If the heating temperature is too high, the coalescence of the protrusions proceeds, the number density is decreased, and an increase in membrane thickness proceeds, and thus good water permeability cannot be obtained. When the microbubbles generated by heating float, microbubbles take the surrounding liquid along to cause a flow, the monomer is dispersed in the liquid, the reaction is promoted, and the densification of the functional layer progresses, prevent the local progress of the reaction and thus the average value of the deformation amount further decreases, and the variation in the deformation amount further decreases.

At this time, as the dissolved gas amount a+b in the amine solution at the solution temperature of 25° C. increases, an amount of gas that cannot be dissolved at the temperature at the time of contact increases, and this effect increases.

Since a difference in gas solubility between at 25° C., and at a high temperature is larger in carbon dioxide than in oxygen, when a ratio b/a of the dissolved amount b of the carbon dioxide to the dissolved amount a of oxygen in the amine solution is 0.9 or more, the above effect can be further obtained, which is preferable. The ratio b/a is more preferably 1.0 or more.

After the reaction and heating, the organic solvent is preferably removed by the step of removing liquid of the organic solvent solution. The removal of the organic solvent can be performed by, for example, a method in which the membrane is held in a vertical direction and an excess organic solvent is removed by naturally flowing down, a method in which the organic solvent is removed by drying by blowing air with a blower, or a method in which the excess organic solvent is removed with a mixed fluid of water and air.

In step (d), the composite semipermeable membrane from which the organic solvent is removed is washed with hot water. A temperature of the hot water is preferably 40° C. to 95° C., and more preferably 60° C. to 95° C. When the temperature of the hot water is 40° C. or more, unreacted substances and oligomers remaining in the membrane can be sufficiently removed. On the other hand, when the temperature of the hot water is 95° C. or less, a shrinkage degree of the composite semipermeable membrane does not increase, and good permeability can be maintained. A preferred range of the temperature of the hot water can be appropriately adjusted according to the polyfunctional aromatic amine or the polyfunctional aromatic acid chloride to be used.

### 3. Use of Composite Semipermeable Membrane

The composite semipermeable membrane can be used in a water treatment system that separates supply water into permeate (fresh water) and concentrate by the composite semipermeable membrane.

Specifically, the composite semipermeable membrane is wound around a tubular water collection pipe in which a large number of holes are bored together with a supply water channel material such as a plastic net, a permeate channel material such as a tricot, and a film for increasing pressure resistance as necessary, to be suitably used as a spiral type composite semipermeable membrane element. Furthermore, a composite semipermeable membrane module in which these elements are connected in series or in parallel and accommodated in a pressure vessel can also be provided.

The composite semipermeable membrane, the element thereof, and the module can constitute a fluid separation device in combination with a pump that supplies supply water thereto, a device that subjects the supply water to pretreatment, and the like. By using the separation device, the supply water can be separated into permeate such as drinking water and concentrate that does not permeate through the membrane to obtain intended water.

Examples of the supply water to be treated by the composite semipermeable membrane according to the present invention include a liquid mixture containing 500 mg/L to 100 g/L of total dissolved solids (TDS) such as seawater, brackish water, and wastewater. In general, TDS refers to an amount of total dissolved solids and is represented by “mass÷volume” or a “weight ratio”. According to the definition, the total dissolved solids can be calculated from a weight of residue obtained by evaporating, at a temperature of 39.5° C. to 40.5° C., a solution filtered through a filter of 0.45 microns and is more conveniently converted from practical salinity (S).

As an operation pressure of the fluid separation device increases, a solute removal rate increases but energy required for operation also increases. In addition, in consideration of durability of the composite semipermeable membrane, the operation pressure when water to be treated permeates through the composite semipermeable membrane is preferably 0.5 MPa to 10 MPa. As a temperature of the supply water increases, the solute removal rate decreases, but as the temperature decreases, the membrane permeation flux also decreases, so the temperature is preferably 5° C. to 45° C. In a case of the supply water having a high solute concentration such as seawater, when the pH of the supply water is increased, there is a concern that scale of magnesium or the like is generated, and there is a concern that the membrane deteriorates due to an operation with high pH, and thus an operation in a neutral region is preferable.

### EXAMPLES

Hereinafter, the present invention will be described with reference to specific examples, but the present invention is not limited to these examples.

Physical properties of the composite semipermeable membrane of the present invention were measured by the following method.

### Deformation Amount and Standard Deviation of Protrusion (Convex Portion)

A composite semipermeable membrane in a wet state with pure water was cut to 1 cm square and fixed to a sample table using an adhesive so that a surface of the separation functional layer faced up to prepare a measurement sample. Next, the measurement sample was fixed on a measurement stage using a magnet, pure water was dropped on the separation functional layer, and the surface was observed with an atomic force microscope (AFM). A force curve of convex portions was taken out ten points from the obtained image, and the deformation amount was analyzed. This operation was performed for two fields of view, and the deformation amounts of 20 points in total were analyzed, and an average value, a maximum value, and a standard deviation were calculated. Specific measurement conditions are as follows.
Device: Dimension FastScan manufactured by Bruker AXS
Scanning mode: nano-mechanical mapping in water
Probe: silicon cantilever (ScanAsyst-Fluid manufactured by Bruker AXS). The cantilever was calibrated before measurement.
Maximum load: 5.0 nN
Scanning range: 2 μm×2 μm
Scanning speed: 0.5 Hz
Number of pixels: 25×256
Measurement condition: in pure water
Measurement temperature: 25° C.

### Quantification of Carboxyl Group, Amino Group, and Amide Group, and Weight of Polyamide

The substrate was physically peeled off from the composite semipermeable membrane of 5 m², and the microporous support layer and the separation functional layer were recovered. The microporous support layer and the separation functional layer were allowed to stand for 24 hours for drying, and then added little by little into a beaker containing dichloromethane and stirred to dissolve the polymer constituting the microporous support layer. An insoluble matter in the beaker was collected with filter paper. The insoluble matter was put into a beaker containing dichloromethane and stirred to collect the insoluble matter again in the beaker. This operation was repeated until elution of the polymer forming the microporous support layer in the dichloromethane solution could not be detected. The recovered separation functional layer was dried in a vacuum dryer to remove the remaining dichloromethane. The weight of the obtained separation functional layer was divided by an area of 5 m² to obtain a polyamide weight per unit area. Further, the separation functional layer was freeze-ground into a powder sample and was sealed in a sample tube used for solid NMR measurement, and ¹³C solid NMR measurement was performed by a CP/MAS method and a DD/MAS method. For ¹³C solid NMR measurement, CMX-300 manufactured by Chemagnetics was used. Measurement conditions were shown below.
Reference material: polydimethylsiloxane (internal reference: 1.56 ppm)
Sample rotation frequency: 10.5 kHz
Pulse repetition time: 100 s

From the obtained spectrum, peak division was performed for each peak derived from a carbon atom to which each functional group was bonded, and a functional group content ratio was determined from an area of the divided peak.

### Average Value of Thickness T of Protrusion and Number Density of Protrusion

The composite semipermeable membrane was cut into a corner of 3 cm×3 cm and washed with distilled water at 25° C. for 24 hours. The washed composite semipermeable membrane was embedded in an epoxy resin, and then dyed with osmium tetroxide to prepare a measurement sample. The obtained sample was observed using a scanning transmission electron microscope (HD 2700 manufactured by Hitachi, Ltd.) with a thin membrane cross-section as an observation surface. Using an acquired image at a magnification of 1,000,000, a shortest distance from a certain point on an external surface to an internal surface of the thin membrane was defined as the thickness T of the thin membrane. The ten convex portions randomly selected were analyzed at five points with respect to one convex portion, and an average value of the points was set as an average value of the thickness T of the thin membrane. Further, the number of folded convex portions was counted, and the average number density was obtained.

### Method for Calculating Dissolved Gas Amount

After the preparation of an amine aqueous solution, oxygen and carbon dioxide were quickly measured using a commercially available DO meter and a dissolved carbon dioxide concentration meter.

### Start and Stop Operation Under High Temperature and High Pressure

The evaluation raw water (having a NaCl concentration of 3.2%) adjusted to have a temperature of 40° C., and pH of 6.5 was supplied to the composite semipermeable membrane under an operation pressure of 7.0 MPa, a start-stop test of operating for 5 minutes and then stopping for 5 minutes was performed 1000 times, and then a membrane filtration treatment was performed. Thereafter, the performance of the composite semipermeable membrane was evaluated by the following method.

### NaCl Transmittance

The evaluation raw water (having a NaCl concentration of 3.2%) adjusted to have a temperature of 25° C., and pH of 6.5 was supplied to the composite semipermeable membrane under an operation pressure of 5.5 MPa to perform a membrane filtration treatment for 24 hours. Thereafter, electrical conductivity of each of the supply water and permeate was measured with an electrical conductometer manufactured by Toa Electric Industrial Co. Ltd. to obtain a NaCl concentration, respectively. NaCl transmittance was calculated according to the following formula from NaCl concentrations in permeate and supply water.

$$NaCl Transmittance ( \% ) = 100 \times ( NaCl Concentration in permeate / NaCl Concentration in supply water )$$

### Membrane Permeation Flux

In the tests described above, an amount of the supply water (evaluation raw water) permeated through the membrane was represented by an amount (cubic meter) of permeate per day per square meter of a membrane surface as a membrane permeation flux (m³/m²/day).

### Reference Example 1

An 18.0 mass % DMF solution of polysulfone (PSf) was cast in a thickness of 200 μm on a polyester nonwoven fabric (air flow rate of 2.0 cc/cm²/sec), immediately immersed in pure water and allowed to stand for 5 minutes to prepare a support membrane.

### Reference Example 2

A DMF solution containing 15 mass % of polysulfone (PSf) was cast in a thickness of 110 μm on a polyester nonwoven fabric (air flow rate of 2.0 cc/cm²/sec), and a DMF solution containing 25 mass % of polysulfone was cast in a thickness of 50 μm at the same time, immediately immersed in pure water of 25° C., and allowed to stand for 5 minutes to prepare a support membrane.

### Reference Example 3

A support membrane was prepared in the same manner as in Reference Example 1 except that a concentration of polysulfone (PSf) in a DMF solution was 20 mass %.

### Comparative Example 1

A support membrane obtained in Reference Example 1 was immersed for 2 minutes in a 6.0 mass % m-phenylenediamine aqueous solution (an example of a polyfunctional aromatic amine solution) in which a dissolved gas amount (a+b, b/a) in an amine aqueous solution was as shown in Table 1. In addition, a+b is a sum of the dissolved amount a of oxygen and the dissolved amount b of carbon dioxide in the amine aqueous solution when a solution temperature is 25° C., and b/a is a ratio of the dissolved amount b of carbon dioxide to the dissolved amount a of oxygen in the amine solution.

The support membrane was slowly pulled up in a vertical direction, and nitrogen was blown from an air nozzle to remove the excessive aqueous solution from a surface of the support membrane. In an environment controlled to 40° C., a decane solution of 40° C. containing 0.16 mass % trimesic acid chloride (TMC) (an example of a polyfunctional aromatic acid halide solution) was applied to completely wet the surface. Next, after the support membrane was heated in an oven at 120° C., in order to remove the excessive solution from the membrane, the membrane was set vertically to remove liquid, and dried by blowing air at 20° C. using a blower. Finally, the membrane was washed with pure water at 90° C. to obtain a composite semipermeable membrane.

### Comparative Example 2

A composite semipermeable membrane according to Comparative Example 2 was obtained in the same manner as in Comparative Example 1 except that a dissolved gas amount in an amine aqueous solution was set to an amount shown in Table 1, 3.0 mass % m-phenylenediamine aqueous solution was used, an Isopar M (manufactured by Exxon Mobil Corporation) solution at 45° C. containing 0.165 mass % TMC was applied to a support membrane in an environment controlled to 45° C., and an oven temperature was further changed to 150° C.

### Comparative Example 3

A composite semipermeable membrane according to Comparative Example 3 was obtained in the same manner as in Comparative Example 1 except that a dissolved gas amount in an amine aqueous solution was set to an amount shown in Table 1 and a step of putting in an oven at 120° C. was omitted, a temperature of a TMC solution was set to 25° C., and the solution was applied in an environment controlled to 25° C.

### Comparative Example 4

A dissolved gas amount in an amine aqueous solution was set to an amount shown in Table 1, an m-phenylenediamine aqueous solution was set to 3.0 mass %, and air was supplied for 30 minutes to dissolve a gas in the air in the aqueous solution. The support membrane obtained in Reference Example 1 was immersed in the amine aqueous solution for 2 minutes, the support membrane was slowly pulled up in a vertical direction, and nitrogen was blown from an air nozzle to remove the excessive aqueous solution from a surface of the support membrane. In an environment controlled to 25° C., a decane solution at 25° C. containing 0.16 mass % of TMC was applied to completely wet the surface. After standing still for 1 minute, in order to remove the excessive solution from the membrane, the membrane was set vertically to remove liquid, and dried by blowing air at 20° C. using a blower. Finally, the membrane was washed with pure water at 90° C. to obtain a composite semipermeable membrane according to Comparative Example 4.

### Comparative Example 5

A composite semipermeable membrane according to Comparative Example 5 was obtained in the same manner as in Comparative Example 1 except that a dissolved gas amount in an amine aqueous solution was set to an amount shown in Table 1, a decane solution at 40° C. containing 0.16 mass % of TMC was applied to completely wet a surface, and then the decane solution containing 0.32 mass % of TMC was applied and heated in an oven at 120° C.

### Comparative Example 6

A composite semipermeable membrane according to Comparative Example 6 was obtained in the same manner as in Comparative Example 3 except that a dissolved gas amount in an amine aqueous solution was set to an amount shown in Table 1, a support membrane obtained in Reference Example 2 was used, a concentration of m-phenylenediamine was set to 4.0 mass %, a concentration of TMC was set to 0.12 mass %, and a washing temperature with pure water in the last was set to 45° C.

### Comparative Example 7

A composite semipermeable membrane according to Comparative Example 7 was obtained in the same manner as in Comparative Example 1 except that a dissolved gas amount in an amine aqueous solution was set to an amount shown in Table 1, isooctane was used as a solvent of a TMC solution, a temperature of the solution was set to 25° C., the solution was applied in an environment controlled to 25° C., and a temperature of an oven was set to 150° C.

### Comparative Example 8

A composite semipermeable membrane according to Comparative Example 8 was obtained in the same manner as in Comparative Example 1 except that a dissolved gas amount in an amine aqueous solution was changed to an amount shown in Table 1.

### Comparative Example 9

A composite semipermeable membrane according to Comparative Example 9 was obtained in the same manner as in Comparative Example 1 except that a dissolved gas amount in an amine aqueous solution was set to an amount shown in Table 1, a concentration of m-phenylenediamine was set to 2.0 mass %, and a concentration of TMC was set to 0.10 mass %.

### Comparative Example 10

A composite semipermeable membrane according to Comparative Example 10 was obtained in the same manner as in Comparative Example 1 except that a dissolved gas amount in an amine aqueous solution was changed to an amount shown in Table 1. The dissolved gas amount was adjusted by degasification.

### Example 1

A support membrane obtained in Reference Example 1 was immersed for 2 minutes in a 3.0 mass % m-phenylenediamine aqueous solution in which a dissolved gas amount was set to an amount shown in Table 1. The support membrane was slowly pulled up in a vertical direction, and nitrogen was blown from an air nozzle to remove the excessive aqueous solution from a surface of the support membrane. In an environment controlled to 40° C., a decane solution at 40° C. containing 0.16 mass % of TMC was applied to completely wet the surface. Next, after being heated in an oven at 150° C., in order to remove the excessive solution from the membrane, the membrane was set vertically to remove liquid, and dried by blowing air at 20° C. using a blower. Finally, the membrane was washed with pure water at 90° C. to obtain a composite semipermeable membrane.

### Example 2

A composite semipermeable membrane according to Example 2 was obtained in the same manner as in Example 1 except that a temperature of an oven was changed to 120° C.

### Example 3

A composite semipermeable membrane according to Example 3 was obtained in the same manner as in Example 1 except that a temperature of an oven was changed to 80° C.

### Example 4

A composite semipermeable membrane according to Example 4 was obtained in the same manner as in Example 1 except that a dissolved gas amount in an amine aqueous solution was changed to an amount shown in Table 1.

### Example 5

A composite semipermeable membrane according to Example 5 was obtained in the same manner as in Example 2 except that a support membrane obtained in Reference Example 3 was used.

### Example 6

A composite semipermeable membrane according to Example 6 was obtained in the same manner as in Example 1 except that in an environment controlled to 55° C., a decane solution at 55° C. containing 0.16 mass % of TMC was applied to completely wet a surface.

### Example 7

A composite semipermeable membrane according to Example 7 was obtained in the same manner as in Example 1 except that a dissolved gas amount in an amine aqueous solution was set to an amount shown in Table 1, and a concentration of an m-phenylenediamine aqueous solution was changed to 8.0 mass %.

### Example 8

A composite semipermeable membrane according to Example 8 was obtained in the same manner as in Example 1 except that a dissolved gas amount in an amine aqueous solution was set to an amount shown in Table 1, and a concentration of an m-phenylenediamine aqueous solution was changed to 2.0 mass %.

### Example 9

A composite semipermeable membrane according to Example 9 was obtained in the same manner as in Example 1 except that a concentration of TMC was 0.10 mass %.

### Example 10

A composite semipermeable membrane according to Example 10 was obtained in the same manner as in Example 8 except that a concentration of TMC was 0.10 mass %.

### Example 11

A composite semipermeable membrane according to Example 11 was obtained in the same manner as in Example 1 except that a dissolved gas amount in an amine aqueous solution was set to an amount shown in Table 1 and when heated in an oven at 150° C., water vapor at 100° C. was supplied from a nozzle provided on a back side of a membrane.

### Examples 12 to 17

A composite semipermeable membrane according to Examples 12 to 17 was obtained in the same manner as in Example 2 except that a dissolved gas amount in an amine aqueous solution was changed to an amount shown in Table 1.

Results of the above are shown in Table 1. From Examples 1 to 17, it can be seen that a composite semipermeable membrane of the present invention is excellent in water permeability and less in salt permeation even after frequent repetition of operation and stop at high temperature and high pressure.

TABLE 1

| | | | | | | | | | Performance after start | |
|---|---|---|---|---|---|---|---|---|---|---|
| | | | | | | | | | and stop operation under | |
| | | | Membrane structure | | | | | | high temperature and high | |
| | | | | Standard | Number | | | | pressure | |
| | | | Deformation | deviation of | density of | | Thickness | | Membrane | |
| | Amine solution | | amount of | deformation | protrusion | | T of | Polyamide | permeation | Transmittance |
| | a + b | b/a | protrusion | amount | (protrusions/ | x + y | protrusion | weight | flux | of salt |
| | mg/L | (—) | (nm) | (nm) | μm) | (—) | (nm) | (g/m²) | (m³/m²/d) | (%) |
| Ex. 1 | 841 | 51.6 | 0.81 | 0.84 | 21.5 | 0.43 | 14.1 | 0.128 | 1.20 | 0.19 |
| Ex. 2 | 841 | 51.6 | 0.98 | 0.97 | 39.4 | 0.49 | 10.0 | 0.111 | 1.27 | 0.22 |
| Ex. 3 | 841 | 51.6 | 2.18 | 1.15 | 24.0 | 0.68 | 12.0 | 0.101 | 1.28 | 0.25 |
| Ex. 4 | 101 | 10.2 | 0.92 | 1.02 | 14.9 | 0.46 | 13.4 | 0.105 | 1.02 | 0.18 |
| Ex. 5 | 841 | 51.6 | 1.00 | 1.13 | 40.4 | 0.52 | 9.7 | 0.108 | 1.30 | 0.29 |
| Ex. 6 | 841 | 51.6 | 1.08 | 0.91 | 15.3 | 0.50 | 18.0 | 0.137 | 0.99 | 0.15 |
| Ex. 7 | 99.7 | 10.5 | 1.32 | 1.04 | 13.1 | 0.61 | 12.0 | 0.098 | 0.91 | 0.23 |
| Ex. 8 | 857 | 50.0 | 2.15 | 1.17 | 16.3 | 0.72 | 9.9 | 0.094 | 1.16 | 0.30 |
| Ex. 9 | 841 | 51.6 | 1.90 | 0.99 | 16.1 | 0.70 | 9.3 | 0.091 | 1.01 | 0.27 |
| Ex. 10 | 857 | 50.0 | 2.11 | 1.10 | 14.0 | 0.77 | 9.3 | 0.083 | 1.00 | 0.29 |
| Ex. 11 | 841 | 51.6 | 0.72 | 0.60 | 13.2 | 0.42 | 16.0 | 0.142 | 0.96 | 0.20 |
| Ex. 12 | 28.1 | 0.004 | 1.44 | 1.15 | 13.5 | 0.63 | 14.3 | 0.097 | 0.88 | 0.23 |
| Ex. 13 | 31.0 | 4.17 | 1.38 | 1.11 | 15.5 | 0.59 | 15.2 | 0.107 | 0.87 | 0.24 |
| Ex. 14 | 9.8 | 0.31 | 1.90 | 1.18 | 13.1 | 0.66 | 11.0 | 0.097 | 0.88 | 0.29 |
| Ex. 15 | 11.0 | 0.57 | 1.34 | 1.16 | 13.3 | 0.61 | 12.3 | 0.115 | 0.85 | 0.26 |
| Ex. 16 | 15.3 | 0.91 | 1.8 | 1.10 | 13.4 | 0.67 | 9.8 | 0.093 | 0.90 | 0.26 |
| Ex. 17 | 17.0 | 1.13 | 1.46 | 0.99 | 15.3 | 0.59 | 12.1 | 0.092 | 0.86 | 0.21 |
| Comp. | 7.2 | 0.06 | 1.45 | 1.25 | 12.9 | 0.60 | 13.2 | 0.098 | 0.72 | 0.27 |
| Ex. 1 | | | | | | | | | | |
| Comp. | 7.5 | 0.06 | 2.21 | 1.10 | 13.0 | 0.71 | 15.0 | 0.093 | 0.77 | 0.29 |
| Ex. 2 | | | | | | | | | | |
| Comp. | 7.3 | 0.06 | 3.77 | 1.29 | 18.0 | 1.00 | 9.5 | 0.075 | 0.73 | 0.36 |
| Ex. 3 | | | | | | | | | | |
| Comp. | 841 | 51.6 | 4.22 | 1.32 | 18.1 | 1.09 | 9.3 | 0.072 | 1.16 | 0.49 |
| Ex. 4 | | | | | | | | | | |
| Comp. | 7.2 | 0.06 | 1.84 | 1.22 | 12.5 | 0.62 | 14.0 | 0.095 | 0.80 | 0.25 |
| Ex. 5 | | | | | | | | | | |
| Comp. | 7.2 | 0.06 | 3.82 | 1.25 | 15.0 | 1.04 | 10.1 | 0.081 | 0.96 | 0.55 |
| Ex. 6 | | | | | | | | | | |
| Comp. | 7.2 | 0.06 | 2.02 | 1.26 | 12.7 | 0.72 | 16.0 | 0.082 | 0.80 | 0.66 |
| Ex. 7 | | | | | | | | | | |
| Comp | 4.8 | 0.12 | 1.8 | 1.05 | 11.5 | 0.66 | 14.0 | 0.092 | 0.78 | 0.30 |
| Ex. 8 | | | | | | | | | | |
| Comp. | 7.3 | 1.35 | 1.82 | 1.23 | 12.1 | 0.67 | 13.0 | 0.088 | 0.79 | 0.26 |
| Ex. 9 | | | | | | | | | | |
| Comp. | 0.8 | 0.14 | 2.21 | 1.23 | 8.0 | 0.81 | 11.7 | 0.081 | 0.77 | 0.35 |
| Ex. 10 | | | | | | | | | | |

Although the present invention has been described in detail with reference to specific embodiments, it is apparent to those skilled in the art that various changes and modifications may be made without departing from the spirit and scope of the present invention. The present application is based on Japanese Patent Application No. 2021-156465 filed on Sep. 27, 2021, and the content thereof is incorporated herein by reference.

### REFERENCE SIGNS LIST

1 composite semipermeable membrane
2 substrate
3 microporous support layer
4 separation functional layer
41 thin membrane
42 convex portion
43 concave portion
A reference line
H1 to H5 height from reference line
D1 to D5 depth from reference line

1. A composite semipermeable membrane comprising:
a microporous support layer; and
a separation functional layer provided on the microporous support layer, wherein
the separation functional layer comprises a plurality of protrusions formed of a thin membrane comprising a cross-linked aromatic polyamide,
in arbitrary ten cross sections perpendicular to a membrane surface direction and having a length of 2.0 μm in the membrane surface direction, an average number density of the protrusions whose height with respect to a surface of the support layer as reference is one-fifth or more of a ten-point average surface roughness of the separation functional layer is 13.0 protrusions/μm or more, and
an average value of a deformation amount when the protrusions are pressed with a force of 5 nN is 2.2 nm or less, and a standard deviation of the deformation amount is 1.2 nm or less.

2. The composite semipermeable membrane according to claim 1, wherein
the average value of the deformation amount when the protrusions are pressed with the force of 5 nN is 1.7 nm or less.

3. The composite semipermeable membrane according to claim 1, wherein
the average number density of the protrusions is 15.0 protrusions/μm or more.

4. The composite semipermeable membrane according to claim 1, wherein
the standard deviation of the deformation amount is 0.98 nm or less.

5. The composite semipermeable membrane according to claim 1, wherein
a value of x+y calculated from amounts of amino groups, carboxyl groups, and amide groups of the separation functional layer is 0.70 or less,
provided that the x is defined as a molar ratio of the carboxyl groups to the amide groups measured by ¹³C solid NMR, and the y is defined as a molar ratio of the amino groups to the amide groups measured by the ¹³C solid NMR.

6. The composite semipermeable membrane according to claim 1, wherein
a thickness of the thin membrane in the protrusion is 10 nm or more and 20 nm or less.

7. The composite semipermeable membrane according to claim 1, wherein
a weight of the separation functional layer is 0.10 g/m² or more.

8. The composite semipermeable membrane according to claim 1, wherein
the separation functional layer comprises a cross-linked fully aromatic polyamide.

9. A method for producing the composite semipermeable membrane according to claim 1, the method comprising:
a step of performing an interfacial polycondensation on a surface of a support membrane comprising a microporous support layer by using a polyfunctional aromatic amine solution in which a sum a+b of a dissolved amount a of oxygen and a dissolved amount b of carbon dioxide in the solution in a case of a solution temperature of 25° C. is 9 mg/L or more and a solution obtained by dissolving a polyfunctional aromatic acid halide in an organic solvent, and then heating to form a cross-linked polyamide functional layer.

10. The method for producing the composite semipermeable membrane according to claim 9, wherein
a ratio b/a of the dissolved amount b to the dissolved amount a is 0.90 or more.

11. A water treatment system for separating a supply water into a concentrate and a fresh water by using the composite semipermeable membrane according to claim 1.
